(19) United States
(12) Patent Application Publication
(10) Pub. No.: US 2005/0125254 A1
(43) Pub. Date: Jun. 9, 2005

(54) Key maintenance method and system

(76) Inventor: Roy Schoenberg, Boston, MA (US)

Correspondence Address: McDermott, Will & Emery, 28 State Street, Boston, MA, 02109, US

(21) Appl. No.: 10/726,952

(22) Filed: Dec. 3, 2003

(51) Int. Cl. G06F 17/60

(52) U.S. Cl. 705/2

(57) ABSTRACT

A key maintenance method and system includes maintaining, in a datastore, a first-level access key that grants, to a medical service provider, a level of access to a set of medical records of a patient. The first-level access key is retrieved and a second-level access key is generated by modifying the level of access of the first-level access key.

### RELATED APPLICATIONS

The following U.S. patent is hereby incorporated by reference into the subject application as if set forth herein in full: (1) U.S. Pat. No. 6,463,417, entitled “Method of Distributing Health Information”.

### FIELD OF THE INVENTION

This invention relates to medical record access control systems, and, more particularly, to medical record access control systems that use keys to regulate the access-level granted to individual medical service providers.

### BACKGROUND

The ability of a patient to regulate the access that a third party has to the patient's medical records has become a hotly-contested topic. Typically, systems that provide the patient with the ability to control access to their medical records (e.g., patient-centric systems) are often administratively-cumbersome for medical service providers. Conversely, systems that are easily administered by medical services providers (e.g., provider-centric systems) compromise the ability of a patient to control access to their medical records.

For patient-centric systems, the patient exclusively controls access to their health care records. Since the patient's healthcare records are centralized and stored in a single location, any provider that accesses the patient's medical record is going to see a complete and current medical record, as all the medical service providers access and amend the same record set.

While the patient-centric system is preferred by patients, it is difficult to implement, since it is often desirable to provide varying levels of access to different medical service providers. Therefore, each medical service provider typically requires a unique access key to gain access to each medical record. Accordingly, this system requires a considerable amount of administrative overhead for medical service providers, in that a medical service provider is required to maintain a unique key for each medical record to which they have access.

For provider-centric systems, the medical service provider maintains a medical record for each patient to which he provides service. Since the medical service provider creates and maintains these medical records, the medical service provider has unfettered access to the medical records. Further, as each of the medical records is not reconciled with the medical records maintained by other medical service providers for the same patient, each medical record represents only a partial record of a patient's medical history.

### SUMMARY OF THE INVENTION

According to a first implementation, a key maintenance method includes maintaining, in a datastore, a first-level access key that grants, to a medical service provider, a level of access to a set of medical records of a patient. The first-level access key is retrieved and a second-level access key is generated by modifying the level of access of the first-level access key.

One or more of the following features may also be included. The levels of access of the first-level and second-level access keys may be defined using one or more access parameters. The set of medical records may be a multi-portion medical record, and the access parameters may provide access to one or more portions of the set of medical records.

The second-level access key may be transmitted to the medical service provider. The medical service provider may subsequently store the second-level access key on an MSP key repository assigned to the medical service provider. The second-level access key may be stored in the datastore. The first-level access key may be deleted from the datastore. The datastore may be a patient key repository assigned to the patient. The first-level access key may have been previously-provided to the medical service provider and may have been previously-stored on an MSP key repository assigned to the medical service provider.

The patient key repository may be a first portion of a centralized key repository, and the MSP key repository may be a second portion of the centralized key repository. The centralized key repository may reside on and may be executed by a remote server connected to a distributed computing network. The remote server may be a web server, and the distributed computing network may be the Internet. The patient key repository and the MSP key repository may be reconciled, which may include overwriting the first-level access key stored within the MSP key repository with the second-level access key stored in the patient key repository.

The second-level access key may enhance the level of access of the first level access key, thus granting the medical service provider a greater level of access to the set of medical records of the patient. Alternatively, the second-level access key may reduce the level of access of the first level access key, thus granting a reduced level of access to the set of medical records of the patient. Further, the second-level access key may revoke the level of access of the first level access key, thus prohibiting the medical service provider from accessing the set of medical records of the patient.

According to a further implementation, a key maintenance system includes a server system having a computer processor and associated memory. The server system has a centralized key repository and is configured to: maintain, in a datastore, a first-level access key that grants, to a medical service provider, a level of access to a set of medical records of a patient; retrieve the first-level access key; and generate a second-level access key by modifying the level of access of the first-level access key.

One or more of the following features may also be included. The server system may be further configured to store the second-level access key in the datastore.

According to a further implementation, a computer program product resides on a computer readable medium on which a plurality of instructions are stored. When executed by the processor, the instructions cause that processor to: maintain, in a datastore, a first-level access key that grants, to a medical service provider, a level of access to a set of medical records of a patient; retrieve the first-level access key; and generate a second-level access key by modifying the level of access of the first-level access key.

One or more of the following features may also be included. The computer program product may further include instructions for storing the second-level access key in the datastore. The computer program product may further include instructions for deleting the first-level access key from the datastore. The computer program product may further include instructions for reconciling the patient key repository and the MSP key repository. The instructions for reconciling may include instructions for overwriting the first-level access key stored within the MSP key repository with the second-level access key stored in the patient key repository.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of key organization system coupled to a distributed computing network;

FIG. 2 is a more-detailed diagrammatic view of the key organization system of FIG. 1;

FIG. 3 is a block diagram of a key maintenance module of the key organization system of FIG. 1;

FIG. 4 is a diagrammatic view of a key configuration display screen rendered by the key organization system of FIG. 1;

FIG. 5 is a block diagram of a key processing module and a record processing module of the key organization system of FIG. 1; and

FIG. 6 is a diagrammatic view of a patient selection display screen rendered by the key organization system of FIG. 1.

### DETAILED DESCRIPTION OF THE PREFERRED EMBODIMENTS

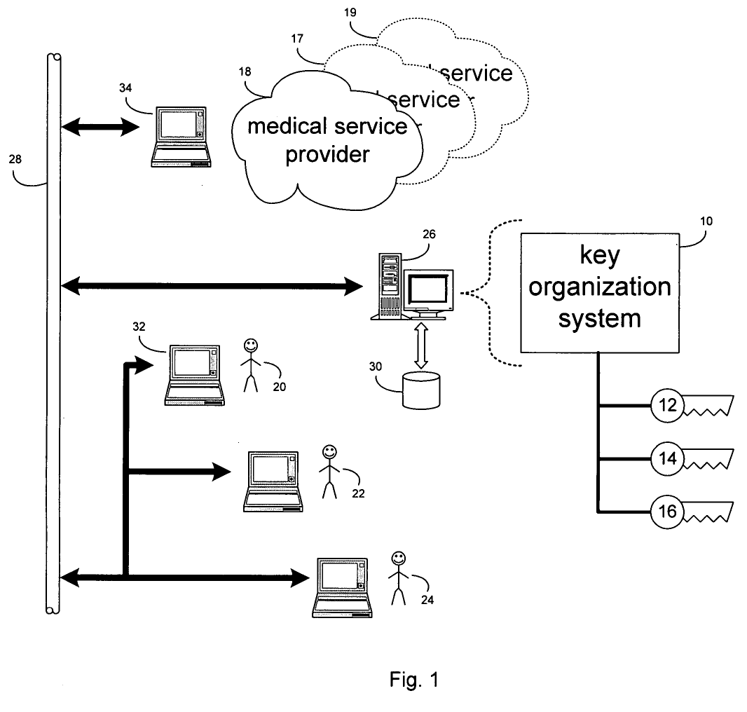

Referring to FIG. 1, there is shown a key organization system 10 that manages the various access keys 12, 14, 16 possessed by a medical service provider 18. Access keys 12, 14, 16 are provided to medical service provider 18 by various patients 20, 22, 24.

Key organization system 10 typically resides on and is executed by a computer 26 that is connected to network 28. Computer 26 may be a web server running a network operating system, such as Microsoft Window 2000 Server™, Novell Netware™, or Redhat Linux™. Typically, computer 26 also executes a web server application, such as Microsoft IIS™, Novell Webserver™, or Apache Webserver™, that allows for HTTP (i.e., HyperText Transfer Protocol) access to computer 26 via network 28.

The instruction sets and subroutines of key organization system 10, which are typically stored on a storage device 30 coupled to computer 26, are executed by one or more processors (not shown) and one or more memory architectures (not shown) incorporated into computer 26. Storage device 30 may be, for example, a hard disk drive, a tape drive, an optical drive, a RAID array, a random access memory (RAM), or a read-only memory (ROM).

As will be explained below in greater detail, a patient (e.g., patient 20) typically provides an access key (e.g., key 12) to medical service provider 18 through a patient computer 32, which is also connected to network 28. Additionally, medical service provider 18 accesses key organization system 10 through a client computer 34.

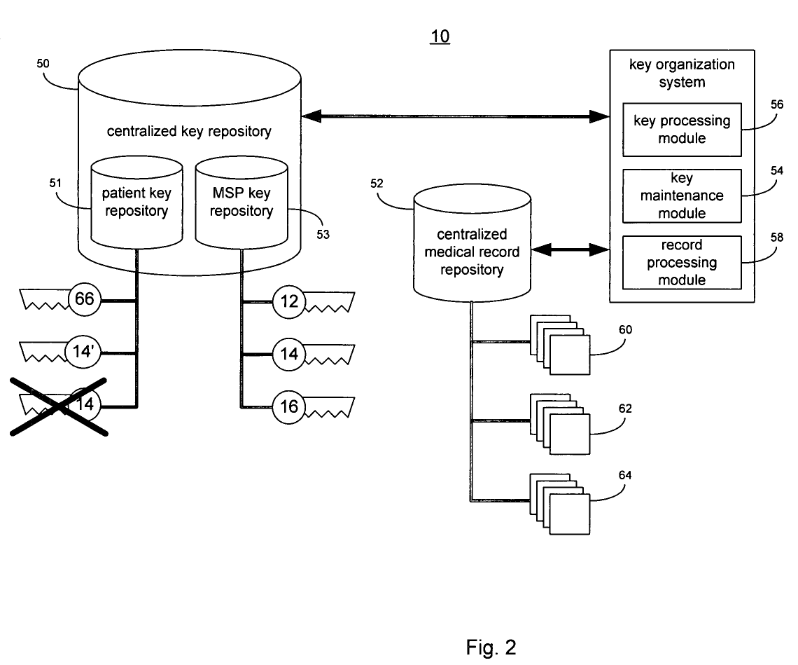

Referring also to FIG. 2, key organization system 10 includes a centralized key repository 50 and a centralized medical records repository 52. Typically, centralized key repository 50 includes one or more patient key repositories 51 and one or more MSP (i.e., medical service provider) key repositories 53. Additionally, key organization system 10 includes a key maintenance module 54, a key processing module 56, and a record processing module 58, each of which will be discussed below in greater detail.

Centralized medical records repository 52 allows for the centralized storage of medical records 60, 62, 64 that concern various patients 20, 22, 24 respectively. As disclosed in U.S. Pat. No. 6,463,417, medical records 60, 62, 64 are typically divided into portions or levels, in that certain portions are considered more confidential than other portions. For example, a portion/level of the medical record that may be considered the least confidential might include general patient identification information and information concerning the patient's blood type and allergies. A portion/level of a medical record that may be considered to have an intermediate level of confidentiality might include information concerning the serological data, psychiatric data, cardiology data, and genetic data. A portion/level of the medical record that may be considered highly confidential may include infectious disease (e.g., HIV, and sexually transmitted diseases) data.

This specific assignment of confidentiality levels and the apportionment of the medical record into various portions/levels is for illustrative purposes only and is not intended to limit the scope of this disclosure.

Medical records 60, 62, 64 may be incrementally generated/configured online by the various medical service providers that provide care to patients 20, 22, 24. Alternatively, existing medical records may be uploaded (i.e., transferred) to medical records repository 52 from a remote storage location (not shown).

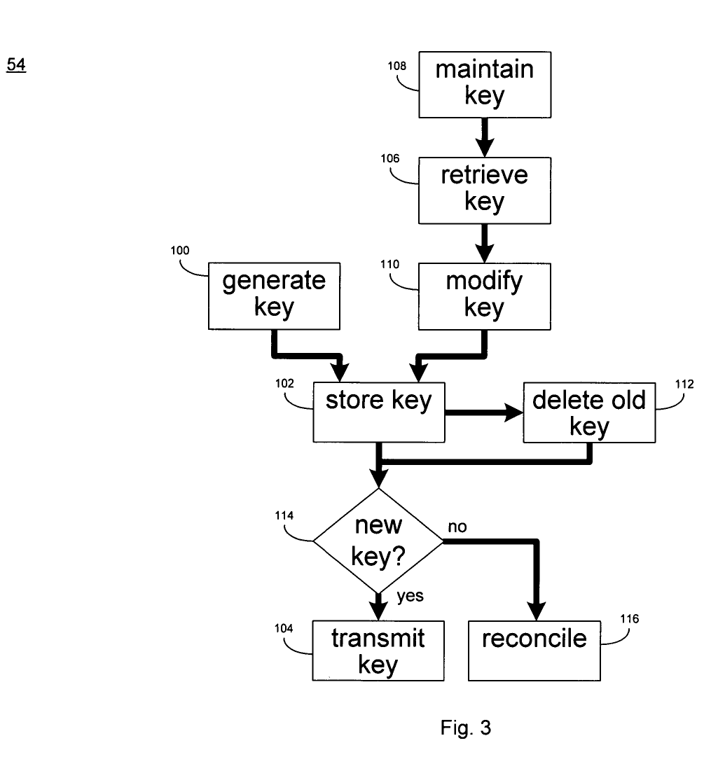

Referring also to FIG. 3, patients 20, 22, 24 use key maintenance module 54 to generate 100 access keys 12, 14, 16 that grant access to various portions of their respective medical records 60, 62, 64. Accordingly, though the use of key maintenance module 54, the patient can generate access keys that not only regulate who has access to their medical records, but can also regulate the level of access (i.e., which portions of a patient's medical record are viewable by the medical service provider to which the key is provided). Examples of access keys 12, 14, 16 are passwords (that allow access to various portions of a medical record) and decryption keys (that decrypt various portions of an encrypted medical record).

Typically, key maintenance module 54 is a web-enabled application that is accessed by the patients (e.g., patient 20) through a browser application (e.g., Microsoft Internet Explorer™, or Netscape Navigator™) that is running on patient computer 32. Alternatively, key maintenance module 54 may be a local application that is executed locally on patient computer 32.

As stated above, key maintenance module 54 allows a patient to generate 100 an access key for a specific medical service provider that grants, to that medical service provider, a defined level of access to that patient's medical records. Once this access key is generated, it is stored 102 on the patient key repository 51 assigned to that patient (i.e., the patient generating the access key).

Once stored 102, the access key is transmitted 104 to the appropriate medical service provider (e.g., medical service provider 18). This transmission of the access key may be implemented by transferring the access key from the patient to the medical service provider. This may occur by attaching the access key to an email that is transmitted to the medical service provider. Once received, the medical service provider may then transfer the newly-generated key to the key processing module 56 (to be discussed below in greater detail) of the key organization system 10. Alternatively, the patient may directly transfer the newly-generated key to the key processing module 54 of the key organization system 10.

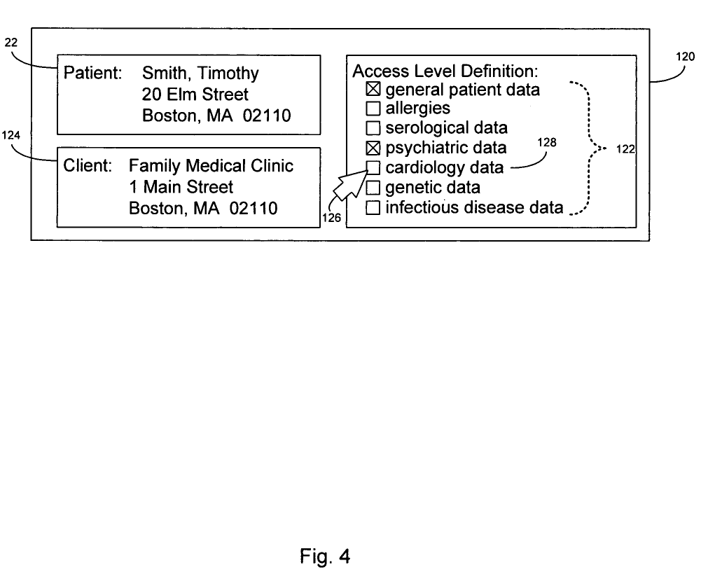

Referring also to FIG. 4, when a patient is generating an access key (e.g., access key 14) for a medical service provider, key maintenance module 54 provides the patient (e.g., patient 22) with a rendered screen display 120 that allows the patient to select one or more access parameters 122 that define the access level granted to that particular medical service provider. Display 120 identifies the patient (i.e., Timothy Smith; patient 22) and allows the patient to select the recipient 124 of the access key being generated by the patient. In this example, the recipient 124 is Family Medical Clinic; medical service provider 18.

As stated above, medical records 60, 62, 64 are typically divided into portions or levels, such that certain portions are considered more confidential than other portions. The access parameters 122 selected (i.e., checked) by the patient define the various portions of the patient's medical record that the medical service provider is going to have access to. In this particular case, the access key being generated by patient Timothy Smith (i.e., patient 22) for the Family Medical Clinic (i.e., medical service provider 18) is going to allow the medical service provider to access only two portions of the patient's medical record, namely the general portion and the psychiatric data. As the remaining access parameters are unchecked, medical service provider 18 is going to be prohibited from accessing any other portion of the patient's medical record. When generating the access key, the patient selects the appropriate access parameters 122 using a mouse pointer 126 (or some other pointing device, not shown).

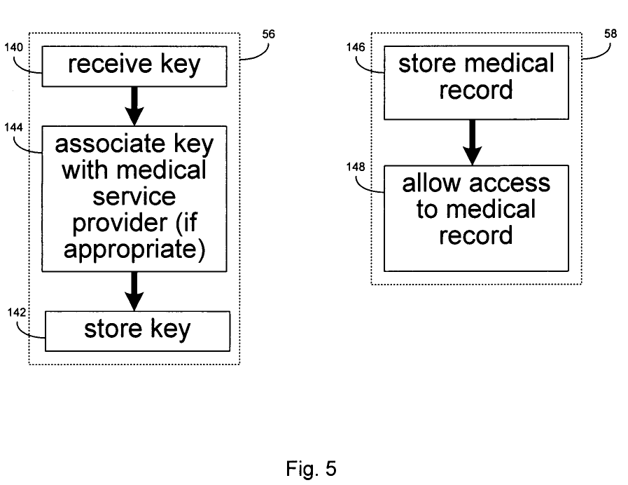

Now referring to FIGS. 1, 2 and 5, regardless of the manner in which the patient transfers the access key to the medical service provider, the access key will ultimately be received 140 by key processing module 56, which receives any access keys (e.g., keys 12, 14, 16) generated and transmitted by patients 20, 22, 24. Once these keys are received 140, they are stored 142 on the MSP key repository 53 within the centralized key repository 50. Additionally, if key organization system 10 is servicing multiple medical service providers (e.g., medical service providers 17 and 19 in addition to medical service provider 18), the received keys are associated 144 with the appropriate medical service provider, thus preventing the keys transmitted to a first provider from being available to a second provider and allowing storage in the appropriate MSP key repository.

When medical records are initially received, initially generated, and/or edited, record processing module 58 stores 146 the medical record on centralized medical record repository 52. Typically, medical record repository 52 is a database that allows for the organized storage and retrieval of the medical records 60, 62, 64.

Once these medical records are stored on medical record repository 52, record processing module 58 allows the medical service provider 18 to access 148 the medical records 60, 62, 64 stored on medical records repository 52. However, the medical service provider 18 is only given access to the portions of the medical records for which the medical service provider 18 possesses the appropriate key. For example, assume that medical service provider 18 is a medical clinic that provides an array of medical services to its patients. Further, assume that patient 20 uses medical service provider 18 for all of their medical needs; patient 22 uses medical service provider 18 solely for treatment of depression; and patient 24 uses medical service provider 18 solely for treatment of HIV.

Concerning the access keys generated by each of these patients for medical service provider 18: patient 20 would typically provide medical service provider 18 with an access key (i.e., key 12) that grants access to their entire medical record; patient 22 would typically provide medical service provider 18 with an access key (i.e., key 14) that grants access to the general and psychiatric portions of their medical record; and patient 22 would typically provide medical service provider 18 with an access key (i.e., key 16) that grants access to the general and infectious disease portions of their medical record.

Record processing module 58 is typically a web-enabled application that is accessed by the medical service provider 18 through a browser application (e.g., Microsoft Internet Explorer™, or Netscape Navigator™) that is running on client computer 34. Typically, medical service provider 18 logs into key organization system 10 using an encrypted SSL (i.e., secure sockets layer) connection.

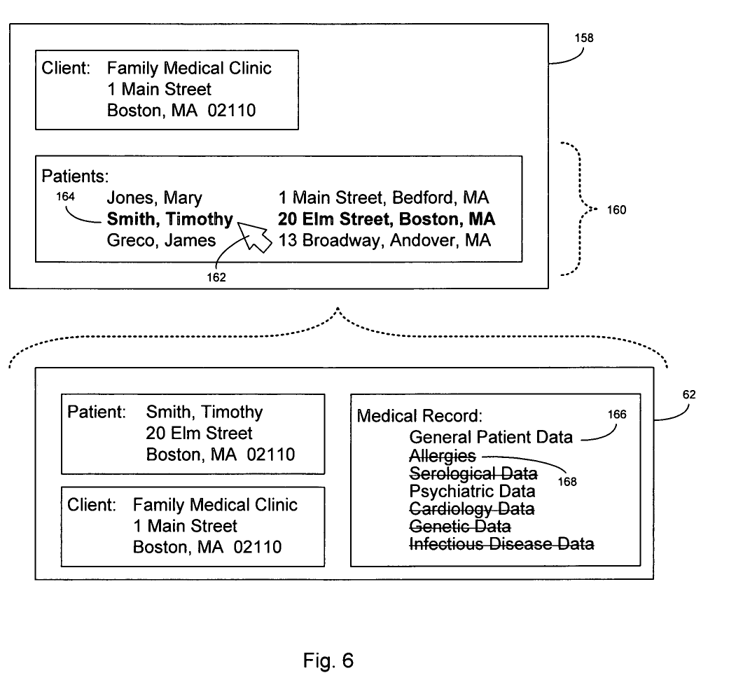

Referring also to FIG. 6, when accessing key organization system 10, record processing module 58 provides the medical service provider 18 with a rendered screen display 158 that includes a list of patient identifiers 160. Patient identifiers 160 define the particular patient(s) who provided access keys to medical service provider 18 (i.e., granting medical service provider 18 access to various portions of their medical record(s)). The patient identifiers 160 may be any element that uniquely identifies the patient, such as the patient's name, the patient's social security number, or a unique patient number. In this particular example, Mary Jones is patient 20, Timothy Smith is patient 22 (as stated above), and James Greco is patient 24.

The presence of each of these names in the list of patient identifiers 160 indicates that a key was received from that patient. In order to access the medical record of a patient for which the medical service provider has an access key (i.e., for one of the patients listed in the list of patient identifiers 160), the medical service provider 18 selects the appropriate identifier using a mouse pointer 162 (or some other pointing device, not shown). For example, if the medical service provider wanted to access the medical record of Timothy Smith (i.e., patient 22), medical service provider 18 would typically double click (using a mouse) on the specific identifier 164 associated with Timothy Smith. Record processing module 58 would then, in turn, use access key 14 to access (i.e., retrieve, decrypt, and display) medical record 62, the medical record of Timothy Smith, i.e., patient 22.

Medical record 62 may be displayed in a separate window or displayed full screen on the display of client computer 34. As discussed above, the key provided to the medical service provider 18 only allows access to the portion(s) of the patient's medical record that the patient wishes to allow access. As discussed above, Timothy Smith (i.e., patient 22) is being treated by medical service provider 18 for depression and access key 14 grants access to the general and psychiatric portions of Timothy Smith's medical record, such that a link (e.g., link 166) to each available portion is displayed on the right-hand side of medical record 64. However, access key 14 does not permit access (i.e., prohibits access) to the other portions of Timothy Smith's medical record, namely Allergies, Serological Data, Cardiology Data, Genetic Data, and Infectious Disease Data. Accordingly, the links (e.g., link 168) to the unavailable data portions are struck-through. Other methods of differentiating the available portions from the unavailable portions of a medical record may be used, such as graying-out or not displaying links to the unavailable portions.

By clicking on the links to the available portions of the medical record, a specific available portion is displayed by record processing module 58.

If the manner in which a patient utilizes a medical service provider changes, key maintenance module 54 allows a patient to modify or revoke the access key previously provided to the medical service provider. Referring again to FIGS. 1, 2, 3 and 4, assume that patient 22 decides that he would like medical service provider 18 to monitor and treat him for a heart valve defect. Accordingly, patient 22 would want medical service provider 18 to have access to the cardiology data portion of their medical record. Therefore, patient 22 would use key maintenance module 54 to retrieve 106 the patient's copy of access key 14, which is being maintained 108 on patient key repository 51. Once retrieved, the patient can use display 120 to modify 110 the access key by adjusting the access parameters selected for that particular medical service provider. Continuing with the above-stated example, patient 22 would selected access parameter 128 (i.e., the parameter that grants access to the cardiology data portion) using mouse pointer 126.

This modified access key (i.e., access key 14′) is then stored 102 on the patient key repository 51. Typically, the storing 102 of the amended version of the access key (i.e., access key 14′) results in the deletion 112 of the older version of the access key (i.e., access key 14) from the patient key repository 51. However, if desired the patient may store the amended access key as a new access key (e.g., access key 66) without deleting the older version of the access key (i.e., access key 14).

As with a newly-generated access key, the amended version of the access key may be transmitted 104 to the appropriate medical service provider (e.g., medical service provider 108). As stated above, the medical service provider would then store amended access key 14′ on their MSP key repository 51, thus allowing the medical service provider to access the patient's medical records with the revised level of access. However, when a determination 114 is made that an access key was amended (as opposed to being a new access key), it may be desirable to reconcile 116 the key repositories. This is due to the fact that if the medical service provider fails to store the amended access key on their MSP key repository, the medical service provider will continue to have the older level of access. This could prove problematic when the patient intends to reduce the level of access afforded to a medical service provider.

When reconciling 116 the patient key repository 51 and the MSP key repository 53, the access keys within the patient key repository are compared to the access keys with the MSP key repository. When this comparison is made, only the access keys (within the patient key repository) that were provided to the “intended-recipient” medical service provider are examined. Further, concerning the access keys within the MSP key repository, only access keys received from the “key-amending” patient are examined.

Continuing with the above-stated example, patient 22 (i.e., Timothy Smith) generated amended key 14′ for medical service provider 18 (i.e., Family Medical Clinic). Therefore, all of the keys (within patient key repository 51) that patient 22 sent to medical service provider 18 are compared to all of the keys (within MSP key repository 53) that medical service provider 18 received from patient 22. Assuming that the original key 14 was deleted from patient key repository 51, the reconciliation process would compare amended key 14′ (stored on patient key repository 51) to original key 14 (stored on MSP key repository 53). As amended access key 14′ is newer than original access key 14, the reconciliation process would overwrite original access key 14 (stored in the MSP key repository) with amended access key 14′ (stored in the patient key repository). As the medical service provider is typically not allowed to modify an access key, whenever different versions of the same access key are present on both the MSP key repository and the patient key repository, the MSP key repository is updated to include the version of the access key present on the patient key repository.

While medical record 64 is shown to include a plurality of links to the available portions of the medical record, other configurations are possible. For example, when clicking on a specific identifier (e.g., identifier 164), a medical record may be displayed that only includes the portions to which the medical service provider has access.

While key maintenance module 54 is described above as amending an access key to provide a medical service provider with an enhanced level of access, other configurations are possible. For example, the access key may be amended to provide a reduced level of access (with respect to the original access key). Further, the access key may be amended so that the amended access parameters do not provide access to any portion of the patient's medical records, effectively prohibiting the medical service provider from accessing the patient's medical records.

While centralized key repository 50, patient key repository 51, and MSP key repository 53 are described above as being located on a remote server, other configurations are possible. For example, the patient key repository may be stored locally on a computer operated by the patient. Further, the MSP key repository may be stored locally on a computer operated by the medical service provider. Additionally, as is known in the art, one or more of these repositories may be distributed across multiple computers/servers.

A number of implementations have been described. Nevertheless, it will be understood that various modifications may be made. Accordingly, other implementations are within the scope of the following claims.

1. A key maintenance method comprising:
maintaining, in a datastore, a first-level access key that grants, to a medical service provider, a level of access to a set of medical records of a patient;
retrieving the first-level access key; and
generating a second-level access key by modifying the level of access of the first-level access key.

2. The key maintenance method of claim 1 wherein:
the levels of access of the first-level and second-level access keys are defined using one or more access parameters;
the set of medical records is a multi-portion medical record; and
the access parameters provide access to one or more portions of the set of medical records.

3. The key maintenance method of claim 1 further comprising transmitting the second-level access key to the medical service provider, wherein the medical service provider subsequently stores the second-level access key on an MSP key repository assigned to the medical service provider.

4. The key maintenance method of claim 1 further comprising storing the second-level access key in the datastore.

5. The key maintenance method of claim 4 further comprising deleting the first-level access key from the datastore.

6. The key maintenance method of claim 4 wherein the datastore is a patient key repository assigned to the patient.

7. The key maintenance method of claim 6 wherein the first-level access key was previously-provided to the medical service provider and previously-stored on an MSP key repository assigned to the medical service provider.

8. The key maintenance method of claim 7 wherein:
the patient key repository is a first portion of a centralized key repository; and
the MSP key repository is a second portion of the centralized key repository.

9. The key maintenance method of claim 8 wherein the centralized key repository resides on and is executed by a remote server connected to a distributed computing network.

10. The key maintenance method of claim 9 wherein:
the remote server is a web server; and
the distributed computing network is the Internet.

11. The key maintenance method of claim 7 further comprising reconciling the patient key repository and the MSP key repository.

12. The key maintenance method of claim 11 wherein reconciling includes overwriting the first-level access key stored within the MSP key repository with the second-level access key stored in the patient key repository.

13. The key maintenance method of claim 1 wherein the second-level access key enhances the level of access of the first level access key, wherein the medical service provider is granted a greater level of access to the set of medical records of the patient.

14. The key maintenance method of claim 1 wherein the second-level access key reduces the level of access of the first level access key, wherein the medical service provider is granted a reduced level of access to the set of medical records of the patient.

15. The key maintenance method of claim 1 wherein the second-level access key revokes the level of access of the first level access key, wherein the medical service provider is prohibited from accessing the set of medical records of the patient.

16. A key maintenance method comprising:
maintaining, in a datastore, a first-level access key that grants, to a medical service provider, a level of access to a set of medical records of a patient;
retrieving the first-level access key;
generating a second-level access key by modifying the level of access of the first-level access key; and
deleting the first-level access key from the datastore

17. The key maintenance method of claim 16 wherein the datastore is a patient key repository assigned to the patient.

18. The key maintenance method of claim 17 wherein the first-level access key was previously-provided to the medical service provider and previously-stored on an MSP key repository assigned to the medical service provider.

19. The key maintenance method of claim 18 wherein:
the patient key repository is a first portion of a centralized key repository; and
the MSP key repository is a second portion of the centralized key repository.

20. The key maintenance method of claim 19 wherein the centralized key repository resides on and is executed by a remote server connected to a distributed computing network.

21. The key maintenance method of claim 20 wherein:
the remote server is a web server; and
the distributed computing network is the Internet.

22. A key maintenance system comprising:
a server system including a computer processor and associated memory, the server system having a centralized key repository and a centralized medical record repository;
wherein the server system is configured to:
maintain, in a datastore, a first-level access key that grants, to a medical service provider, a level of access to a set of medical records of a patient;
retrieve the first-level access key; and
generate a second-level access key by modifying the level of access of the first-level access key.

23. The key maintenance system of claim 22 wherein the server system is further configured to store the second-level access key in the datastore.

24. The key maintenance system of claim 23 wherein the datastore is a patient key repository assigned to the patient.

25. The key maintenance system of claim 24 wherein the first-level access key was previously-provided to the medical service provider and previously-stored on an MSP key repository assigned to the medical service provider.

26. The key maintenance system of claim 25 wherein:
the patient key repository is a first portion of a centralized key repository; and
the MSP key repository is a second portion of the centralized key repository.

27. The key maintenance system of claim 26 wherein the centralized key repository resides on and is executed by a remote server connected to a distributed computing network.

28. The key maintenance system of claim 27 wherein:
the remote server is a web server; and
the distributed computing network is the Internet.

30. A computer program product residing on a computer readable medium having a plurality of instructions stored thereon which, when executed by the processor, cause that processor to:
maintain, in a datastore, a first-level access key that grants, to a medical service provider, a level of access to a set of medical records of a patient;
retrieve the first-level access key; and
generate a second-level access key by modifying the level of access of the first-level access key.

31. The computer program product of claim 30 further comprising instructions for storing the second-level access key in the datastore.

32. The computer program product of claim 30 further comprising instructions for deleting the first-level access key from the datastore.

33. The computer program product of claim 30 wherein the datastore is a patient key repository assigned to the patient.

34. The computer program product of claim 33 wherein the first-level access key was previously-provided to the medical service provider and previously-stored on an MSP key repository assigned to the medical service provider.

35. The computer program product of claim 34 further comprising instructions for reconciling the patient key repository and the MSP key repository.

36. The computer program product of claim 35 wherein the instructions for reconciling include instructions for overwriting the first-level access key stored within the MSP key repository with the second-level access key stored in the patient key repository.
